(19) United States
(12) Patent Application Publication
(10) Pub. No.: US 2026/0010001 A1
(43) Pub. Date: Jan. 8, 2026

(54) NOVEL WAVEGUIDE SYSTEM FOR A NEAR-EYE DISPLAY

(71) Applicant: Lumus Ltd., Ness Ziona (IL)

(72) Inventor: Yochay DANZIGER, Kfar Vradim (IL)

(73) Assignee: Lumus Ltd., Ness Ziona (IL)

(21) Appl. No.: 19/129,413

(22) PCT Filed: Jan. 30, 2024
(86) PCT No.: PCT/IB2024/050853

§ 371 Date: May 13, 2025

Related U.S. Application Data
(60) Provisional application No. 63/524,688, filed on Jul. 2, 2023.
(60) Provisional application No. 63/524,978, filed on Jul. 5, 2023.
(60) Provisional application No. 63/516,853, filed on Jul. 31, 2023.
(60) Provisional application No. 63/518,077, filed on Aug. 7, 2023.
(60) Provisional application No. 63/534,842, filed on Aug. 27, 2023.

(51) Int. Cl. G02B 27/00; G02B 17/00; G02B 27/01

(52) U.S. Cl. CPC G02B 27/0081; G02B 17/006; G02B 27/0172; G02B 2027/0178

(57) ABSTRACT

A waveguide system for a near-eye display may include a first waveguide section and a second waveguide section. The first waveguide section may include a first set of at least partially reflecting surfaces configured to couple light corresponding to the image out of the first waveguide section so as to expand the aperture in a first dimension. The second waveguide section may be disposed on a side of the first waveguide section and configured to receive light from the first waveguide section and including a second set of partially reflecting surfaces configured to couple out light corresponding to the image so as to expand the aperture in a second dimension nonparallel to the first dimension.

### FIELD

The present disclosure relates to the field of near eye display systems such as head-mounted displays. More specifically, the present disclosure relates to a compact waveguide system designed for near eye displays (NEDs).

### BACKGROUND

Consumer demands for improved human-computer interfaces have led to an increased interest in high-quality image head-mounted displays (HMDs) or near-eye displays (NED), commonly known as smart glasses. These devices can provide virtual reality (VR) or augmented reality (AR) experiences, enhancing the way users interact with digital content and their surrounding environment.

Consumers are seeking better image quality, immersive experiences, and greater comfort when using HMDs. They expect displays with high resolution, vibrant colors, and minimal distortion to create a realistic and enjoyable viewing experience. Additionally, comfort is a crucial factor since users often wear these devices for extended periods. Consumers desire lightweight, sleek designs that are less obtrusive and more convenient to wear in various scenarios. Smaller devices also offer improved portability, making them easier to carry and use in different environments. As such, there is a growing demand for higher performing yet smaller and more compact HMDs.

A critical element in traditional near-eye display systems is the waveguide. It is a device that guides light from a system image projector to the user's eyes. Waveguides rely on total internal reflection along the major surfaces within the device to propagate light. There are inherent limitations in miniaturizing waveguides, which in turn restricts the miniaturization of head-mounted displays. For example, conventional features that would assist more efficient illumination of the waveguides tend to increase their size. In another example, conventional features that would assist in miniaturization of waveguides tend to reduce image quality or aesthetic appeal of the near-eye display system.

Another critical element of the near-eye display systems is the projector. In the context of HMDs and NEDs, an image projector is a device that generates and projects visual content onto an intermediate medium (i.e., the waveguide) to be delivered to the eye. The goal is to provide the user with the perception of images or videos, often with the illusion of depth or three-dimensionality. Conventional projectors did not contribute to the stated goal compactness of the HMD.

Therefore, there is a demand for innovative compact illuminations systems including compact waveguide systems and novel projectors that would contribute to compactness of the NED.

### SUMMARY

The present disclosure is directed towards the utilization of reflective elements to reduce the size of waveguide systems. In one embodiment, a reflective element allows for the folding of the interface between a first waveguide section (HLOE) and a second waveguide section (LOE) in a waveguide system, reducing its overall size. In another embodiment, a reflective element allows for the introduction of illumination enhancing elements that are concealed within a frame of the near-eye display.

The present disclosure is also directed to projector designs that enable the miniaturization of waveguide elements by selectively and efficiently projecting light beams corresponding to a projected image.

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

### BRIEF DESCRIPTION OF THE DRAWINGS

FIG. 1A illustrates an exemplary near-eye display (NED).

FIG. 1B shows schematically the concept of a two-dimensional aperture expansion (aperture multiplication) for a NED.

FIG. 2 illustrates a novel waveguide system for a NED.

FIG. 3 illustrates a novel waveguide system for a NED.

FIG. 4 illustrates a novel waveguide system for a NED.

FIG. 5 illustrates a waveguide system for two-dimensional aperture expansion.

FIG. 6A illustrates an alternative waveguide system for two-dimensional aperture expansion.

FIG. 6B illustrates an alternative waveguide system for two-dimensional aperture expansion.

FIG. 7 illustrates a schematic view of an exemplary projector to control light beam distribution at the projector aperture.

FIG. 8A illustrates a schematic view of another exemplary projector to control light beam distribution at the projector aperture.

FIG. 8B illustrates a schematic view of another exemplary projector corresponding to the projector of FIG. 8A but using LCOS technology and a polarizing beam splitter (PBS).

FIG. 9A illustrates a schematic view of another exemplary projector designed to control light beam distribution at the projector aperture.

FIG. 9B illustrates a schematic view of another exemplary projector corresponding to the projector of FIG. 9A but using LCOS technology and a polarizing beam splitter (PBS).

FIG. 10A illustrates a schematic view of another exemplary projector to control light beam distribution at the projector aperture.

FIG. 10B illustrates a schematic view of another exemplary projector corresponding to the projector of FIG. 10A but using a polarizing beam splitter (PBS).

FIGS. 11A, 11B, and 11C illustrate an alternative waveguide system similar to the system of FIG. 5 but modified so that a waveplate is at the edge of the waveguide system.

FIG. 12A illustrates an alternative waveguide system similar to the system of FIG. 11A but modified to include at least one modified partial reflector.

FIG. 12B illustrates a first alternative magnified view of the system of FIG. 12A.

FIGS. 13A and 13B illustrate a waveguide system corresponding to the configuration of FIG. 12A.

FIGS. 14A, 14B, and 14C illustrate an exemplary production process for constructing the system as shown in FIG. 12A.

FIG. 15 illustrates a waveguide system similar to the system of FIG. 12A, but here the reflective surface is segmented as parallel reflective surfaces.

FIGS. 16A, 16B, and 16C illustrate a waveguide system that combines features of the system of FIG. 6 and the system of FIG. 12A.

### DETAILED DESCRIPTION

Certain embodiments of the present invention provide an optical system and a light projecting system for achieving optical aperture expansion for the purpose of, for example, head-mounted displays (HMDs) or near-eye displays, commonly known as smart glasses, which may be virtual reality or augmented reality displays. Consumer demands for better and more comfortable human computer interfaces have stimulated demand for better image quality and for smaller devices.

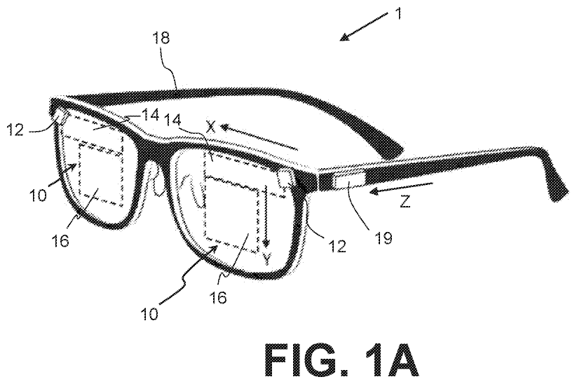

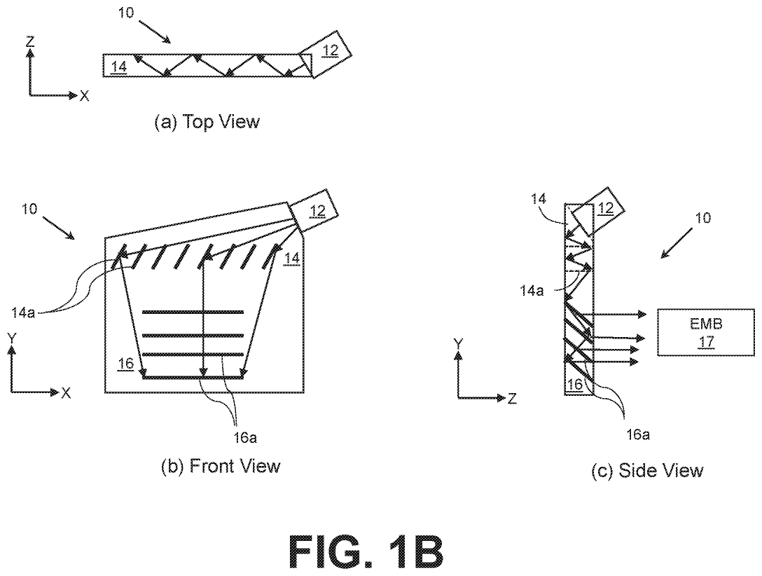

An exemplary implementation of a device in the form of a near-eye display according to the teachings of an embodiment of the present invention, generally designated 1, employing a waveguide system 10, is illustrated schematically in FIG. 1A. The near-eye display (NED) 1 employs a compact image projector (or “POD”) 12 optically coupled so as to inject an image into waveguide system (interchangeably referred to as “substrate” or “slab”) 10 within which the image light is trapped in one dimension by internal reflection at a set of mutually-parallel planar external surfaces.

Optical aperture expansion is achieved within waveguide system 10 by one or more arrangements for progressively redirecting the image illumination, typically employing a set of partially-reflecting surfaces (interchangeably referred to as “facets”) that may be parallel to each other and inclined obliquely to the direction of propagation of the image light, with each successive facet deflecting a proportion of the image light into a deflected direction. As illustrated in FIG. 1A, two-dimensional aperture expansion is achieved by employing a first waveguide section 14 that transmits the light along the X direction and a first set of facets in waveguide section 14 to progressively redirect the image illumination within the waveguide system 10 in the Y direction, also trapped/guided by internal reflection.

The deflected image illumination then passes into a second waveguide section 16, which may be implemented as an adjacent distinct substrate or as a continuation of a single substrate, in which a coupling-out arrangement (for example, a further set of partially reflective facets) progressively couples out a portion of the image illumination in the Z direction towards the eye of an observer located within a section defined as the eye-motion box (EMB), thereby achieving a second dimension of optical aperture expansion. Similar functionality may be obtained using diffractive optical elements (DOEs) for redirecting and/or coupling-out of image illumination within one or both of sections 14 and 16.

The overall device may be implemented separately for each eye and is preferably supported relative to the head of a user with each waveguide system 10 facing a corresponding eye of the user. In one particularly preferred option as illustrated here, a support arrangement is implemented as an eye glasses frame 18 with sides for supporting the device relative to ears of the user. Other forms of support arrangement may also be used, including but not limited to, head bands, visors or devices suspended from helmets.

Reference is made herein in the drawings and claims to an X axis which extends horizontally (or, in alternative embodiments, vertically), in the general extensional direction of the first section 14 of the waveguide system 10, a Y axis which extends perpendicular thereto, i.e., vertically in FIG. 1A (or, in alternative embodiments, horizontally), and a Z axis which extends perpendicular thereto, i.e., horizontal towards the eye of the user. In very approximate terms, the first section 14 of waveguide system 10, may be considered to achieve aperture expansion in the X direction while the second section 16 of waveguide system 10 achieves aperture expansion in the Y direction. The details of the spread of angular directions in which different parts of the field of view propagate will be addressed more precisely below. It should be noted that the orientation as illustrated in FIG. 1A may be regarded as a “top-down” implementation, where the image illumination entering the second section 16 of the waveguide system 10 enters from the top edge, whereas an alternative orientation may be regarded as a “side-injection” implementation, where the axis referred to here as the Y axis is deployed horizontally.

In the remaining drawings, the various features of certain embodiments of the present invention will be illustrated in the context of a “top-down” orientation, similar to FIG. 1A. However, it should be appreciated that all of those features are equally applicable to side-injection implementations, which also fall within the scope of the invention. In certain cases, other intermediate orientations are also applicable, and are included within the scope of the present invention except where explicitly excluded. The two-dimensional expansion embodiments illustrated here are merely exemplary, but the invention is also applicable to embodiments in which only a single dimension of aperture expansion is performed by the waveguide system 10.

It will be appreciated that the near-eye display 1 includes various additional components, typically including a controller 19 for actuating the image projector 12, typically employing electrical power from a small onboard battery (not shown) or some other suitable power source. It will be appreciated that controller 19 includes all necessary electronic components such as at least one processor or processing circuitry to drive the image projector 12.

Large field of view waveguides for NED, such as the waveguide system 10, require large surface area that is not always available ergonomically. FIG. 1B shows schematically the concept of a two-dimensional aperture expansion (aperture multiplication) for a NED. Image projector 12 projects collimated light beams representing an image at infinity (two arrows represent the beams of the edge of the image). The light from projector 12 enters waveguide system 10 and propagates while in one dimension being guided by total internal reflection (TIR) and in the other dimension diverging (different beams of different parts of the image diverge). The beams propagate within the waveguide system 10 and specifically first section 14 (also referred to as HLOE) by total internal reflection as shown in FIG. 1B(a) Top View. The beams impinge on embedded partial reflectors 14a of first section 14 as shown in FIG. 1B(b) Front View and redirect toward partial reflectors 16a of second section 16 (also referred to as LOE) that reflect the beams out of the waveguide system 10 and toward the observer or eye motion box (EMB) 17 as shown in FIG. 1B(c) Side View.

Partial reflectors 14a and 16a multiply the aperture laterally and vertically, respectively. The length, position and spacing of facets 14a and 16a may vary (shown as same distance for clarity) for achieving an optimal and uniform projected image. Facets 14a and 16a may be perpendicular or oblique relative to external faces of the HLOE 14 and LOE 16, respectively. A waveplate may be introduced between HLOE 14 and LOE 16 to improve reflectivity. A longitudinal partial reflector (homogenizer) may be introduced before the HLOE 14 (improved light injection) or after the HLOE 14 for better image uniformity.

Solutions for 2D expansion utilizing the aforementioned HLOE and LOE are commercially available from Lumus Ltd. (Israel), and details of such waveguide systems can be found in, for example, commonly owned International Patent Application Publication WO 2020/049542 A1.

The waveguide system 10 of FIGS. 1A and 1B is relatively large, particularly in the height (Y) dimension, which makes corresponding NED 1 relatively large and bulky. NED users, however, seek greater comfort. Comfort is a crucial factor since users often wear these devices for extended periods. Consumers desire lightweight, sleek designs that are less obtrusive and more convenient to wear in various scenarios. Smaller devices also offer improved portability, making them easier to carry and use in different environments. As such, there is a growing demand for smaller and more compact NED. Miniaturization of waveguides would allow for smaller, more comfortable NED. However, conventionally, there have been limitations in miniaturizing waveguides, which in turn restricts the miniaturization of NED.

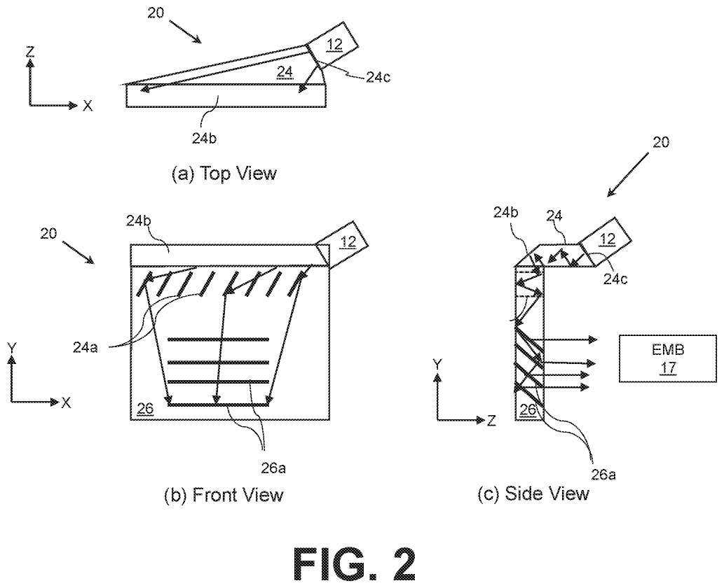

FIG. 2 illustrates a novel waveguide system 20 for a NED 1. FIG. 2 shows that it is possible to fold the first waveguide section 24 of waveguide system 20 (optically equivalent to the first section 14 of waveguide system 10 of FIGS. 1A and 1B) in order to achieve an ergonomic configuration. The first waveguide section 24 has an aperture 24c through which light beams corresponding to an image from the image projector 12 enter the waveguide system 20. In the first waveguide section 24, light beams propagate in a first dimension (e.g., X) and a second dimension (e.g., Z), nonparallel (e.g., perpendicular) to the first dimension. The first waveguide section 24 guides light in the Y dimension by total internal reflection.

At its end, the first section 24 includes a redirecting component 24b (e.g., folding mirror) that redirects the light beams to propagate in a third dimension (e.g., Y) nonparallel (e.g., perpendicular) to the first dimension (e.g., X) and the second dimension (e.g., Z) towards partial reflectors 24a. The partial reflectors 24a expand the aperture in the first dimension (e.g., X) and redirect the beams towards partial reflectors 26a of second section 26. The second waveguide section 26 receives and propagates the light beams in the third dimension (e.g., Y). The second waveguide section 26 guides light in the Z dimension by total internal reflection. The second set of partially reflecting surfaces 26a couple out the image in the second dimension (e.g., Z) so as to expand the aperture in the third dimension (e.g., Y).

In this configuration the height (Y) of the waveguide system 20 is significantly lower than the height (Y) of the waveguide system 10 and the triangular shape of first section 24 fits the edge of the NED 1, where there is space (in the Z dimension) between the waveguide system 20 and the face of the user. The angle between sections 24 and 26 may vary according to ergonomic requirements and to optical optimization. Depending on the angle between sections 24 and 26, the reflector 24b may be replaced with a prism. The thickness of guiding sections 24 and 26 may be different from each other. In one embodiment, the first section 24 is thicker than the second section 26 so that section 26 may be better illuminated.

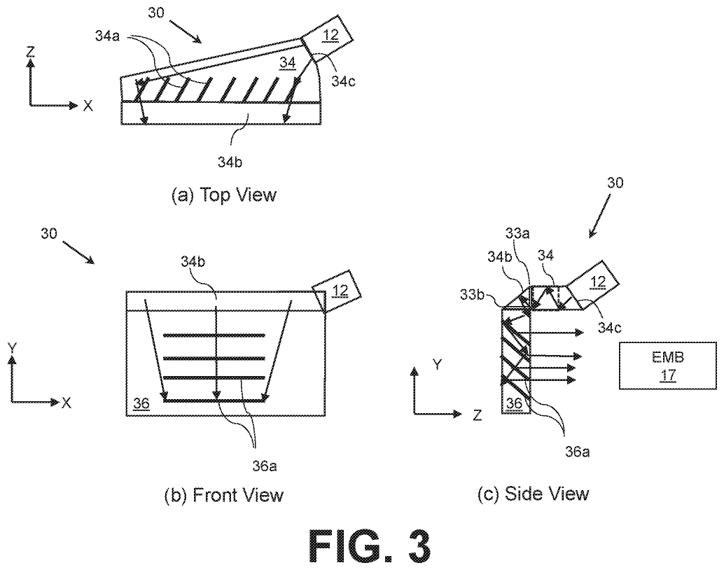

FIG. 3 illustrates a novel waveguide system 30 for a NED 1. FIG. 3 shows a configuration even more compact (in the height Y dimension) than the system 20 of FIG. 2. In system 30, the partial reflectors 34a are located above the fold (versus below the fold as in the system 20 of FIG. 2) and act to redirect the beams similar to the system 20 of FIG. 2.

The first waveguide section 34 has an aperture 34c through which light beams corresponding to the image from the image projector 12 enter the waveguide system 30. In the first waveguide section 34, light beams propagate in a first dimension (e.g., X) and a second dimension (e.g., Z), nonparallel (e.g., perpendicular) to the first dimension. The first waveguide section 34 guides light in the Y dimension by total internal reflection. The first waveguide section 34 also has partial reflectors 34a that expand the aperture in the first dimension (e.g., X). At its end, the first section 34 includes a redirecting component 34b (e.g., folding mirror) that redirects the light beams to propagate in a third dimension (e.g., Y) nonparallel (e.g., perpendicular) to the first dimension (e.g., X) and the second dimension (e.g., Z) towards the second waveguide section 36. The second waveguide section 36 receives and propagates the light beams in the third dimension (e.g., Y). The second waveguide section 36 guides light in the Z dimension by total internal reflection. The second waveguide section 36 has partial reflectors 36a that couple out the image in the second dimension (e.g., Z) so as to expand the aperture in the third dimension (e.g., Y).

In this configuration the height (Y) of the waveguide system 30 is significantly lower than the height (Y) of the waveguide system 10 and the triangular shape of first section 34 fits the edge of the NED 1, where there is space (in the Z dimension) between the waveguide system 30 and the face of the user. The angle between sections 34 and 36 may vary according to ergonomic requirements and to optical optimization. Depending on the angle between sections 34 and 36, the reflector 34b may be replaced with a prism. The thickness of guiding sections 34 and 36 may be different from each other. In one embodiment, the first section 34 is thicker than the second section 36 so that section 36 may be better illuminated.

In one embodiment, the prism supporting mirror 34b may have an interface 33a with the HLOE 34 and an interface 33b with the LOE 36. One of these interfaces or both may have a low refractive index relative to the respective waveguide or air gap. This type of interface may reduce losses and improve coupling between the HLOE 34 and the LOE 36.

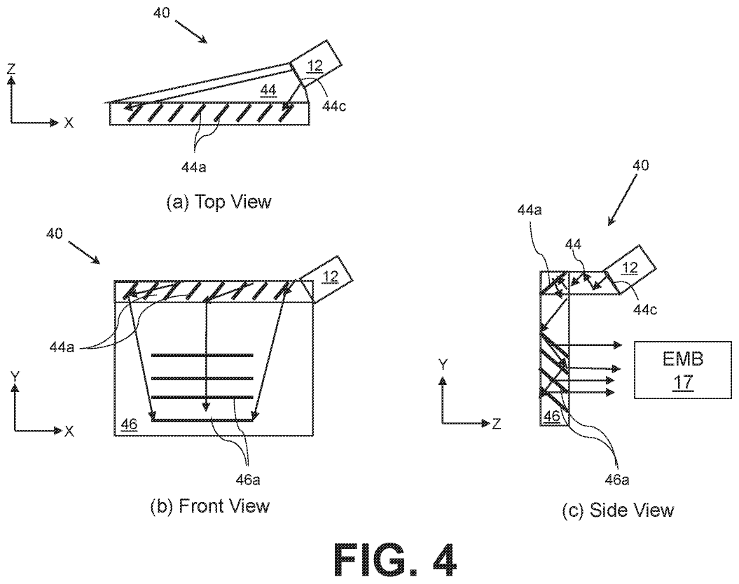

FIG. 4 illustrates a novel waveguide system 40 for a NED 1. FIG. 4 shows a configuration more compact (in the height Y dimension) than the system 10 of FIG. 1. The HLOE partial reflectors 44a are set at an oblique angle relative to waveguide sections 44 and 46. These HLOE partial reflectors 44a are located at the interface between sections 44 and 46 and serve both for reflection from waveguide section 44 to waveguide section 46 and to partially transmit (partially reflect) the light beams for lateral (in the X dimension) expansion. Therefore, here oblique HLOE facets 44a serve to perform both functionalities as performed by the partial reflectors 24a, 34a and reflecting component 24b, 34b of FIGS. 2 and 3, respectively.

The first waveguide section 44 has an aperture 44c through which light beams corresponding to the image from the image projector 12 enter the waveguide system 40. In the first waveguide section 44, light beams propagate in a first dimension (e.g., X) and a second dimension (e.g., Z), nonparallel (e.g., perpendicular) to the first dimension. The first waveguide section 44 guides light in the Y dimension by total internal reflection. The partial reflectors 44a expand the aperture in the first dimension (e.g., X). The partial reflectors 44a also redirect the light beams in a third dimension (e.g., Y) nonparallel (e.g., perpendicular) to the first dimension (e.g., X) and the second dimension (e.g., Z) towards the second waveguide section 46. The second waveguide section 46 receives and propagates the light beams in the third dimension (e.g., Y). The second waveguide section 46 guides light in the Z dimension by total internal reflection. The second waveguide section 46 has partial reflectors 46a that couple out the image in the second dimension (e.g., Z) so as to expand the aperture in the third dimension (e.g., Y).

In this configuration the height (Y) of the waveguide system 40 is significantly lower than the height (Y) of the waveguide system 10 and the triangular shape of first section 44 fits the edge of the NED 1, where there is space (in the Z dimension) between the waveguide system 40 and the face of the user. The angles of facets 44a may vary according to ergonomic requirements and to optical optimization. The thickness of guiding sections 44 and 46 may be different from each other. In one embodiment, the first section 44 is thicker than the second section 46 so that section 46 may be better illuminated.

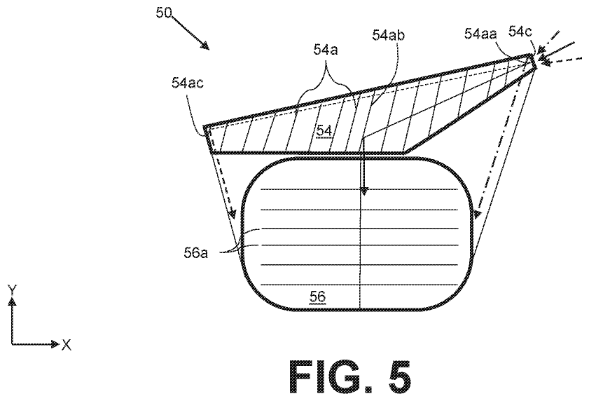

FIG. 5 illustrates a waveguide system 50 for two-dimensional aperture expansion in a 1D waveguide. Here, three beams are traced: the solid arrow of the center of the field, the dashed arrow representing rays on one edge of the field and the dot-dashed arrow representing rays on the opposite edge of the field. All field rays may be injected into the waveguide system 50 through a single narrow pupil or aperture 54c. Therefore, the aperture of the projector 12 (not shown) in this plane may have a relatively small aperture corresponding to the aperture 54c. As the beams propagate in HLOE 54, some of the light is reflected by facets 54a down towards LOE 56 and its facets 56a. The first edge's reflection (dot-dashed) is reflected near the aperture 54c at 54aa while center (solid arrow) ray is reflected at 54ab and the other image's edge is reflected (dashed) at 54ac.

A potential problem with this arrangement is that it necessitates a relatively large HLOE section 54 (with facets 54a) that is ergonomically not optimal for use in NED implementation.

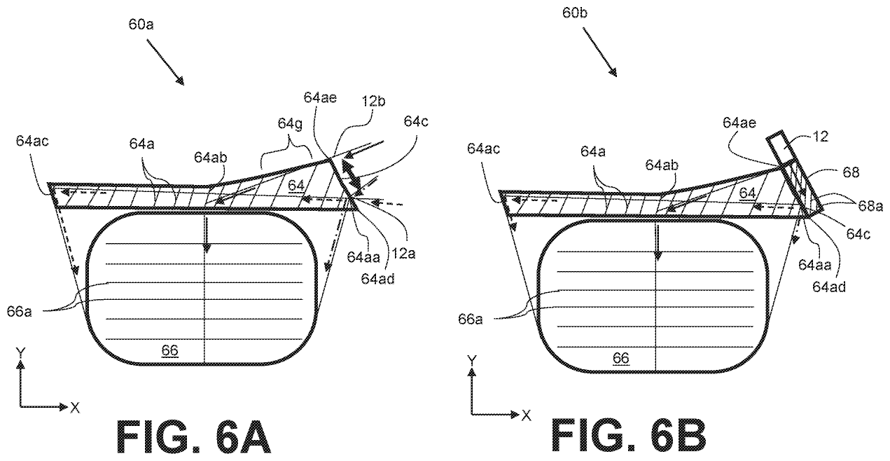

FIG. 6A illustrates an alternative waveguide system 60a in which the light beams do not enter the waveguide from the same point, as in system 50 of FIG. 5. In this configuration both side image beams enter the waveguide from point 12a while center image beams enter the waveguide from point 12b. Consequently, the projector aperture 64c is wider to project all beams generating the full image. In this configuration, the HLOE facets 64a reflect the beams but from different points 64aa, 64ab, 64ac. The new arrangement of reflection points enables a much smaller layout for HLOE 64 that may be ergonomically acceptable for NED implementation.

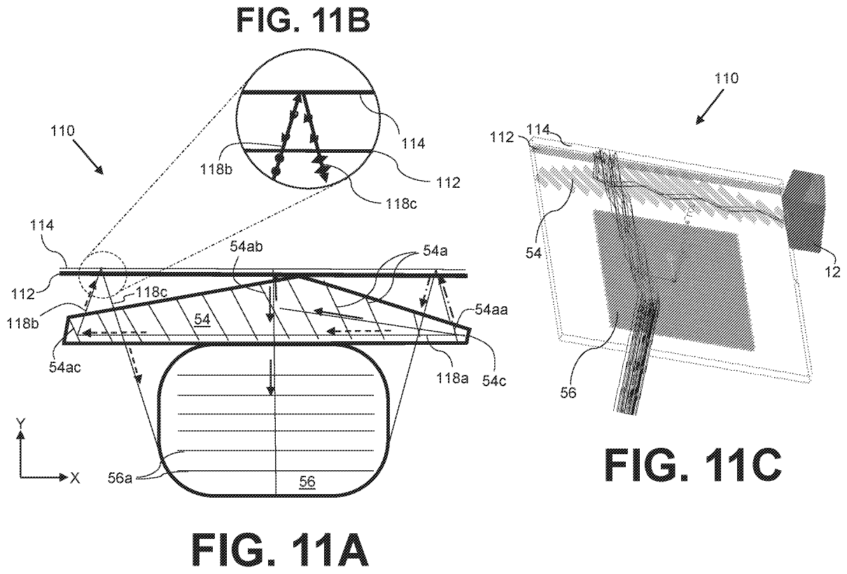

The waveguide system 60a includes a first waveguide section 64 and a second waveguide section 66. Although this disclosure refers to the first waveguide section 64 and the second waveguide section 66 as different sections, these waveguide sections may be implemented as part of a single waveguide or waveguide assembly. See, for example, FIG. 11C.

The first waveguide section 64 has an aperture 64c through which light beams corresponding to an image from an image projector (not shown) enter the waveguide system 60a.

The first waveguide section 64 includes a first set of at least partially reflecting surfaces 64a. The first set of at least partially reflecting surfaces 64a couples light corresponding to the image out of the first waveguide section 64 so as to expand the aperture in a first dimension (e.g., X).

The second waveguide section 66 receives light from the first waveguide section 64 and includes a second set of partially reflecting surfaces 66a that couple out light corresponding to the image so as to expand the aperture in a second dimension (e.g., Y) nonparallel (e.g., perpendicular) to the first dimension (e.g., X).

As shown in FIG. 6A, a first extreme light beam (corresponding to a pixel on the image's edge) is at least partially reflected by a first extreme at least partially reflecting surface 64aa. A second extreme light beam (corresponding to a pixel on the image's opposite edge) is at least partially reflected by a second extreme at least partially reflecting surface 64ac, which is disposed at an opposite end of the waveguide section 64. A center light beam (corresponding to a pixel at the center of the image) is at least partially reflected by a third at least partially reflecting surface 64ab disposed between the first and second extreme at least partially reflecting surfaces 64aa and 64ab, respectively. The first set of at least partially reflecting surfaces 64a couples the light corresponding to the image out of the first waveguide section 64 toward the second waveguide section 66.

Facet section 64g shows schematically that the spacing between the facets 64a may vary along the HLOE 64 in accordance with the corresponding illuminating aperture. The larger the aperture 64c the larger the spacing needed between facets 64a.

FIG. 6B illustrates an alternative waveguide system 60b, corresponding to the system 60a of FIG. 6A but where the input image light from the projector 12 is coupled into a preliminary waveguide 68. The waveguide 68 (can be two-fold or three-fold light guiding) performs preliminary aperture expansion to fit the extended width of the aperture 64c of the HLOE 64. The preliminary waveguide 68 has internal partially reflective facets 68a that receive the image light from the projector 12 and perform preliminary aperture expansion to fit the width of the aperture 64c.

The partially reflective facets 68a of the waveguide 68 may be designed such that aperture illumination illuminating sections of the HLOE 64 may vary per section. For example, illumination from the edges (64ad or 64ae) may have smaller aperture illumination compared with the central part of aperture 64c. In addition, the spacing between the facets 64a may vary along the HLOE 64 in accordance with the local aperture illumination. The larger the aperture illumination, the larger the spacing needed between corresponding facets 64a.

FIG. 6C shows configuration 60c equivalent to 60a in FIG. 6A where two adjacent projectors 201a and 201b project the image in two parts instead of one as shown in 60a. The two side by side projectors 201a and 201b generate a practical extended projecting aperture (equivalent to 64c in 60a) where every projector's aperture is fully illuminated and every projector illuminates a different image field and different section of waveguide 66. Projector 201a projects light-beams 203 that reflect to 205 on side of waveguide section 66. The same projector 201a projects beam 207a (and the beams in between, not shown for clarity) that reflects in waveguide section 64 onto beam 209 at the center of the field.

Projector 201b projects beam 211 that reflects to beam 213 and projects beam 207b (parallel to 207a) that reflects to 209 thereby overlapping the beam 209 originated from beam 207a from projector 201a. Projector 201b also projects the beams between 209 and 213 thereby projecting the other half of the field with some overlap with projector 201a.

The facets in waveguide sections 64 and/or 66 of the above configurations may be replaced with diffractive gratings having approximately the same orientation. The extended input aperture (same as described above) may include input coupling with reflector, prism, or diffracting element(s).

Using two or more projectors 201a, 201b as shown in FIG. 6C enables using uniform illuminated small projectors that are simple to produce while gaining benefit from a large aperture having a smaller waveguide section 64. If multiple projectors are not desired, the light distribution illustrated in FIG. 6A may necessitate a novel projector.

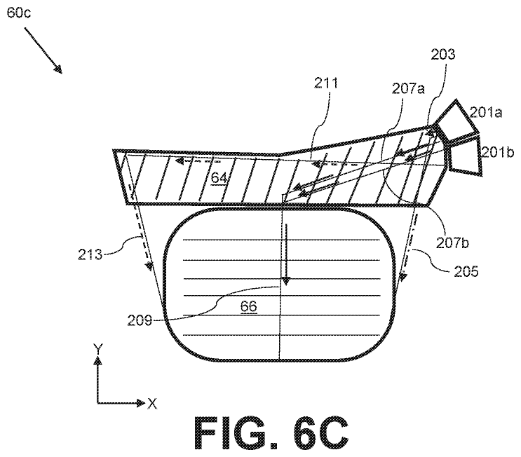

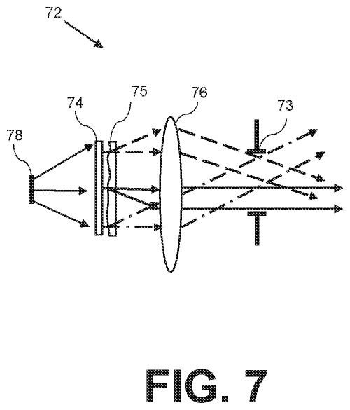

FIG. 7 illustrates a schematic view of an exemplary projector 72 designed to control light beam distribution at the projector aperture 73. Exemplary projector 72 generates the beam distribution corresponding to aperture 64c of FIG. 6A where side image beams enter the waveguide from point 12a while center image beams enter the waveguide from point 12b. In FIG. 7, light beams are marked as in FIG. 6A: solid for center field, dashed for field edges.

The image projector 72 may include a projector aperture 73 corresponding to the aperture 64c of the first waveguide section 64. The image projector 72 may also include an image generator matrix 74 such as, for example, Micro-LED, OLED, front illuminated LCOS, DLP, LCD, etc. illuminated by a light source 78 such as, for example, LED, laser, or scanning laser. The matrix 74 may generate the image to be projected, projecting light beams for every pixel. The image projector 72 may also include a collimating lens 76 that receives and collimates light corresponding to the image generated by the matrix 74. The image projector 72 may also include a phase element 75 disposed relative to the matrix 74 and the collimating lens 76 to control light beam distribution at the projector aperture 73. In FIG. 7, phase element 75 is disposed between the matrix 74 and the collimating lens 76 to control light beam distribution at the projector aperture 73.

The phase element 75 may be a transparent wafer with a relief pattern formed thereon or a diffractive optical element through which one or more light beams travel. The profile of phase element 75 is defined to generate the required beam distribution. One or more light beams corresponding to a center field of the image as generated by the matrix 74 exit the projector aperture 73 at an edge of the of the projector aperture 73 and one or more light beams corresponding to an edge field of the image as generated by the matrix 74 exit the projector aperture 73 at a center of the projector aperture 73. This is such that, in the context of FIG. 6A, side image beams enter the waveguide from point 12a while center image beams enter the waveguide from point 12b on the aperture 64c.

In one preferred embodiment, phase element 75 is disposed in close proximity to the matrix 74 so that the image is not distorted. Lens 76 collimates the light beams emerging from phase 75 onto the aperture 73.

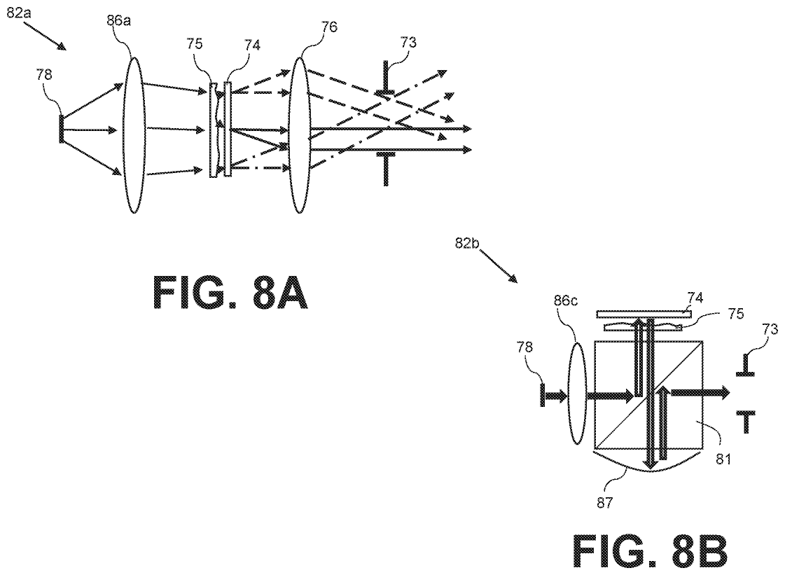

FIG. 8A illustrates a schematic view of another exemplary projector 82a designed to control light beam distribution at the projector aperture 73. The exemplary projector 82a generates the beam distribution corresponding to aperture 64c of FIG. 6A where side image beams enter the waveguide from point 12a while center image beams enter the waveguide from point 12b. In FIG. 8A, light beams are marked as in FIG. 6A: solid for center field, dashed for field edges.

The image projector 82a may include projector aperture 73 corresponding to the aperture 64c of the first waveguide section 64. The image projector 82a may also include the image generator matrix 74 illuminated by the light source 78. The matrix 74 may generate the image to be projected, projecting light beams for every pixel. The image projector 82a may also include a collimating lens 76 that receives and collimates light corresponding to the image generated by the matrix 74. In FIG. 8A, the collimating lens 76 is disposed optically between the projector aperture 73 and the matrix 74. The image projector 72 may also include a phase element 75 disposed relative to the matrix 74 and the collimating lens 76 to control light beam distribution at the projector aperture 73. In FIG. 8A, phase element 75 is disposed optically between the light source 78 and the matrix 74 to control light beam distribution at the projector aperture 73. The image projector 72 may also include optics 86a disposed optically between the light source 78 and the phase element 75 to optimize optical power coupling at the projector aperture 73 while minimizing optical power required by the phase element 75.

In FIG. 8A, phase element 75 is disposed optically between the light source 78 and the matrix 74 and in close proximity to the matrix 74. This arrangement may be applicable for transparent LCD matrix 74 or for LCOS where phase element 34 may be an active in one direction diffuser such as a polarization selective diffuser. In other embodiments, the phase element 75 may be disposed on the other side of the matrix 74 or split between both sides (also applicable as simple phase element adjacent to LCOS active before and after reflection) of the matrix 74.

FIG. 8B illustrates a schematic view of another exemplary projector 82b corresponding to the projector 82a of FIG. 8A but using LCOS technology and a polarizing beam splitter (PBS) 81. Here, phase element 75 is traversed twice, before and after being reflected by LCOS matrix 74, therefore the phase for single pass is half the phase needed.

The projector 82b includes projector aperture 73 corresponding to the aperture 64c of the first waveguide section 64 of FIG. 6A. The projector 82b also includes the light source 78 and the LCOS matrix 74 disposed optically between the projector aperture 73 and the light source 78. The matrix 74 receives light from the light source 78 and generates the image to be projected. The projector 82b also includes phase element 75 disposed optically between the light source 78 and the matrix 74 to control light beam distribution at the projector aperture 73. The projector 82b also includes the PBS 81 disposed optically between the light source 78 and the projector aperture 73. The PBS 81 reflects the first polarity of light from the light source 78 to the matrix 74 through the phase element 75. The matrix 74 changes the polarity of the light. The PBS 81 reflects a second polarity of light from the matrix 74 through the phase element 75 to a polarizing reflector 87, which again changes the polarity of light. The first polarity of light is reflected from the polarizing reflector 87 to the projector aperture 73. The projector 82b also includes optics 86c disposed optically between the light source 78 and the phase element 75 to optimize optical power coupling at the projector aperture 73 while minimizing optical power required by the phase element 75.

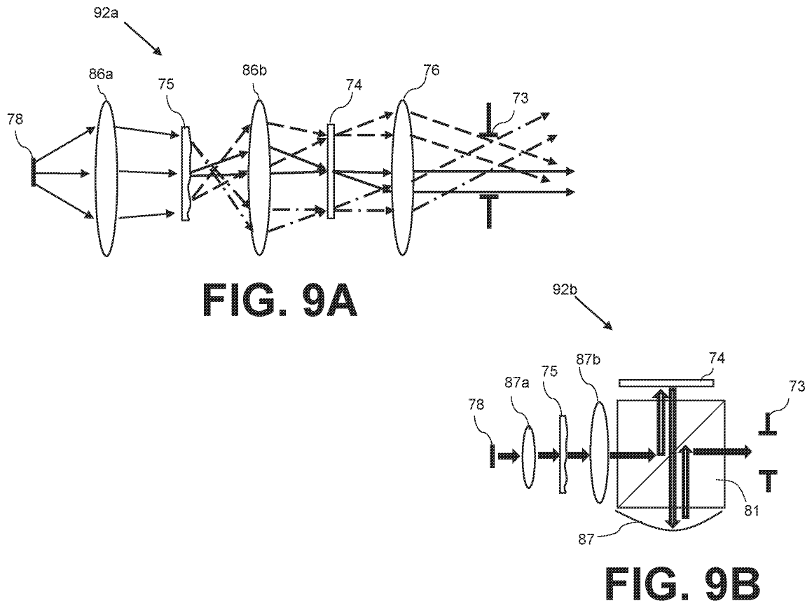

FIG. 9A illustrates a schematic view of another exemplary projector 92a designed to control light beam distribution at projector aperture 73. Exemplary projector 92a generates the beam distribution corresponding to aperture 64c of FIG. 6A where side image beams enter the waveguide from point 12a while center image beams enter the waveguide from point 12b. In FIG. 9A, light beams are marked as in FIG. 6A: solid for center field, dashed for field edges. Projector 92a is an extended configuration needed when it is not practical to implement phase element 75 adjacent the matrix 74. In such a case, phase element 75 forms a conjugate to the plane of matrix 74 and the light source 78 forms a conjugate to the aperture 73.

As in previous projectors, here light source 78 illuminates the phase element 75 via optics 86a and the phase element 75 is imaged onto the matrix 74 via optics 86b. The image projector 92a may also include a collimating lens 76 that receives and collimates light corresponding to the image generated by the matrix 74 and transmits the collimated light to the aperture 73.

The projector 92a may include a projector aperture 73 corresponding to the aperture 64c of the first waveguide section 64. Projector 92a may also include a light source 78 and a matrix 74 disposed optically between the projector aperture 73 and the light source 78. The matrix 74 receives light from the light source 78 and generates the image to be projected. Projector 92a may also include a collimating lens 76 disposed optically between the projector aperture 73 and the matrix 74. Lens 76 may receive and collimate light corresponding to the image generated by the matrix 74. Projector 92a may also include a phase element 75 disposed optically between the light source 78 and the matrix 74 to control light beam distribution at the projector aperture 73. The projector 92a may also include optics 86a and 86b disposed optically between the light source 78 and the phase element 75 and between the phase element 75 and the matrix 74, respectively. The optics 86a and 86b optimize optical power coupling at the projector aperture 73 while minimizing optical power required by phase element 75.

FIG. 9B illustrates a schematic view of another exemplary projector 92b corresponding to the projector 92a of FIG. 9A but using LCOS technology and a polarizing beam splitter (PBS) 81. The phase element 75 is traversed twice, before and after being reflected by LCOS matrix 74, therefore the phase for single pass is half the phase needed.

Projector 92b may include a projector aperture 73 corresponding to the aperture 64c of the first waveguide section 64, a light source 78, and a matrix 74 disposed optically between the projector aperture 73 and the light source 78. The matrix 74 receives light from the light source 78 and generates the image to be projected. Projector 92a may also include a phase element 75 disposed optically between the light source 78 and the matrix 74 to control light beam distribution at the projector aperture 73. The projector 92a may also include PBS 81 disposed optically between the light source 78 and the projector aperture 73 to reflect a first polarity of light from the light source 78 to the matrix 74 through the phase element 75, a second polarity of light from the matrix 74 to a polarizing reflector 87, and the first polarity of light from the polarizing reflector 87 to the projector aperture 73. The projector 92a may also include optics 87a disposed optically between the light source 78 and the phase element 75 and optics 87b disposed between the phase element 75 and the matrix 74 to optimize optical power coupling at the projector aperture 73 while minimizing optical power required by the phase element 75.

Alternatively, each reflective pixel element on the LCOS is produced at tilt that fits the required local phase. For example, if a reflected beam from one of the pixels in the LCOS need to emerge from the side of the aperture then the reflective element of this pixel within the LCOS will be produced. On the other hand, if the beam needs to emerge from the center of the aperture, then the reflective element within the LCOS matrix may be flat.

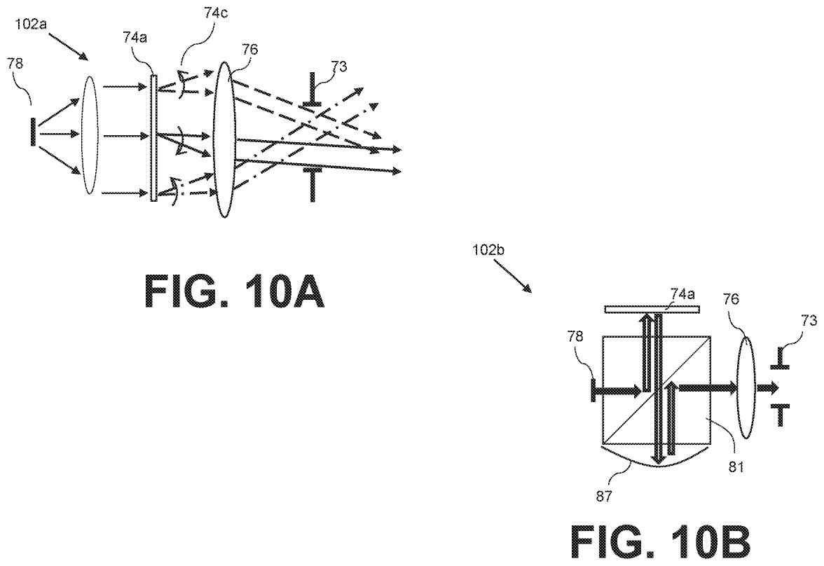

FIG. 10A illustrates a schematic view of another exemplary projector 102a designed to control light beam distribution at the projector aperture 73. Exemplary projector 102a generates the beam distribution corresponding to aperture 64c of FIG. 6A where side image beams enter the waveguide from point 12a while center image beams enter the waveguide from point 12b. In FIG. 10A, light beams are marked as in FIG. 6A: solid for center field, dashed for field edges. In projector 102a, each reflective pixel element on the LCOS matrix 74a is produced at a tilt that fits the required local phase. For example, if a reflected beam from the one of the pixels in the LCOS matrix 74a needs to emerge from the side of the aperture 73, then the reflective element of this pixel within the LCOS matrix 74a will be produced tilted in direction shown by arrow 74c. On the other hand, if that beam needs to emerge from the center of the aperture 73, then the reflective element within the LCOS matrix 74a will be flat.

Projector 102a may include a projector aperture 73 corresponding to the aperture 64c of the first waveguide section 64, the light source 78, and a LCOS matrix 74a disposed optically between the projector aperture 73 and the light source 78. The matrix 74a receives light from the light source 78 and generates the image to be projected. Each reflective pixel element on the matrix 74a is set at a respective tilt (direction shown as arrows 74c) to control light beam distribution at the projector aperture 73.

“Tilt” in this context refers to the orientation change of the liquid crystal molecules in the LCOS matrix that adjusts the polarization of the reflected light. By adjusting the electric field applied to each pixel, the light intensity for each pixel may be modulated. This controls which pixels are light and which are dark managing the light pattern that forms the image, effectively setting each reflective pixel element at a respective tilt to control light beam distribution at the projector aperture 73. Therefore, the light distribution at the projector aperture 73 may be controlled by manipulating the polarization of the light reflected from each pixel at the matrix 74a. The lens 76 may receive and collimate light corresponding to the image generated by the matrix 74a.

Each reflective pixel element on the matrix 74a may be set at a respective tilt such that one or more light beams corresponding to a center field of the image exit the projector aperture 73 at an edge of the of the projector aperture 73. Similarly, each reflective pixel element on the matrix 74a may be set at a respective tilt such that one or more light beams corresponding to an edge field of the image exit the projector aperture 73 at a center of the projector aperture 73.

FIG. 10B illustrates a schematic view of another exemplary projector 102b corresponding to the projector 102a of FIG. 10A but using a polarizing beam splitter (PBS) 81. Exemplary projector 102b generates the beam distribution corresponding to aperture 64c of FIG. 6A where side image beams enter the waveguide from point 12a while center image beams enter the waveguide from point 12b. In the projector 102b, each reflective pixel element on the LCOS matrix 74a is produced at a tilt that fits the required local phase as explained above. If a reflected beam from the one of the pixels in the LCOS matrix 74a needs to emerge from the side of the aperture 73, then the reflective element of this pixel within the LCOS matrix 74a will be produced. On the other hand, if that beam needs to emerge from the center of the aperture 73, then the reflective element within the LCOS matrix 74a will be flat.

The projector 102b may include a projector aperture 73 corresponding to the aperture 64c of the first waveguide section 64, a light source 78, and a matrix 74a disposed optically between the projector aperture 73 and the light source 78. The matrix 74a receives light from the light source 78 and generates the image to be projected. The projector 102b may also include a PBS 81 disposed optically between the light source 78 and the projector aperture 73 to reflect a first polarity of light from the light source 78 to the matrix 74a, a second polarity of light from the matrix 74a to a polarizing reflector 87, and the first polarity of light from the polarizing reflector 87 to the projector aperture 73. The lens 76 may receive and collimate light corresponding to the image generated by the matrix 74a.

Each reflective pixel element on the matrix 74a may be set at a respective tilt such that one or more light beams corresponding to a center field of the image exit the projector aperture 73 at an edge of the of the projector aperture 73. Similarly, each reflective pixel element on the matrix 74a may be set at a respective tilt such that one or more light beams corresponding to an edge field of the image exit the projector aperture 73 at a center of the projector aperture 73.

The coatings of facets, such as facets 54a in FIG. 5, may be polarization selective, where S-polarization is partially reflected and P-polarization is mostly transmissive. Therefore, introducing a waveplate between the waveguides 54 and 56 may be beneficial so that light beams impinge at S-polarization onto the facets 54a. However, a waveplate at that location between the waveguides 54 and 56 will likely be visible to the user and introduce undesired reflections, degrading the projected image's quality.

FIGS. 11A, 11B, and 11C illustrate an alternative waveguide system 110 similar to the system 50 of FIG. 5 but modified so that a waveplate 112 is at the edge of the waveguide system 110, thereby preventing undesired reflections. The waveguide system 110 also includes a reflecting surface (e.g., mirror) 114 to reflect the light back through the HLOE 54 to the LOE 56. As in FIG. 5, three beams are traced: the solid arrow of the center of the field, the dashed arrow representing rays on one edge of the field, and the dot-dashed arrow representing rays on the opposite edge of the field. Light (all field rays) from projector 12 may be injected into the waveguide system 110 through a single narrow pupil or aperture 54c.

Although only beam 118 is discussed here in detail, all beams follow the same optical process relating to the waveplate 112 and the reflecting surface 114. Beam 118a is coupled into system 110 through the aperture 54c and propagates along the waveguide section 54. At this stage, beam 118 is S-polarized. The beam 118a impinges on facet 54ac (in this case the last facet in waveguide section 54 is of importance) that is arranged at an angle to reflect the beam 118a away from facet 54ac as beam 118b towards the waveplate 112 and the reflecting surface 114. That is, the facet 54ac (as well as the rest of the facets 54a) are angled to reflect light in the opposite direction to the facets in system 50 of FIG. 5.

In FIG. 11B, dots represent S polarization, curved arrows represent circular polarization, and double arrows represent P polarization. The beam 118b reaches quarter waveplate 112, which changes the beam's polarization from S to circular. After the beam 118b passes through the quarter waveplate 112 it is circularly polarized and then it is reflected from reflecting surface 114 (e.g., dielectric or metallic mirror) back toward waveguide section 54. The reflected beam 118c passes again through quarter waveplate (e.g., retarder) 112 to now become P polarized beam 118c.

The P polarized beam 118c passes through waveguide section 54 with minimal reflection and impinging on facets 56a of waveguide section 56. When reflected by the facets 56a, the polarization of the beam 118c is S polarization therefore output reflection is optimal.

As shown in FIG. 11C (a perspective view of the system 110), placement of the reflector 114 and the waveplate 112 adjacent to the edge of the system 110 makes it possible for the conspicuity of these elements to be minimal. For example, these elements 112 and 114 (placed at the edge of the square shown in FIG. 11C) may be disposed within a frame 18 of the NED 1 to cover or hide the elements 112 and 114 within frame 18.

Therefore, the waveguide system 110 may include a first waveguide section 54 having an aperture 54c through which light beams corresponding to the image from the image projector 12 enters the waveguide system 110. The first waveguide section 54 includes a first set of at least partially reflecting surfaces 54a. The first set of at least partially reflecting surfaces 54a couples light corresponding to the image out of the first waveguide section 54 away from the second waveguide section 56 towards the reflector 114 and/or the waveplate 112 so as to expand the aperture in a first dimension (e.g., X).

The waveguide system 110 may also include the second waveguide section 56 that receives light from the first waveguide section 54 and includes a second set of partially reflecting surfaces 56a to couple out light corresponding to the image so as to expand the aperture in a second dimension (e.g., Y) nonparallel (e.g., perpendicular) to the first dimension (e.g., X).

The waveguide system 110 may also include the quarter waveplate 112 and one or more reflectors 114 disposed on a side of the first waveguide section 54 opposite to the side where the second waveguide section 56 is disposed such that (1) the first set of at least partially reflecting surfaces 54a couples the light corresponding to the image out of the first waveguide section 54 towards the quarter waveplate 112 and the one or more reflectors 114, (2) the quarter waveplate 112 rotates polarization of the light a quarter wave, (3) the one or more reflectors 114 reflect the light back through the quarter waveplate 112, (4) the quarter waveplate 112 rotates polarization of the light an additional quarter wave to be, for example, P polarized, and (5) the light travels through the first waveguide section 54 towards the second waveguide section 56.

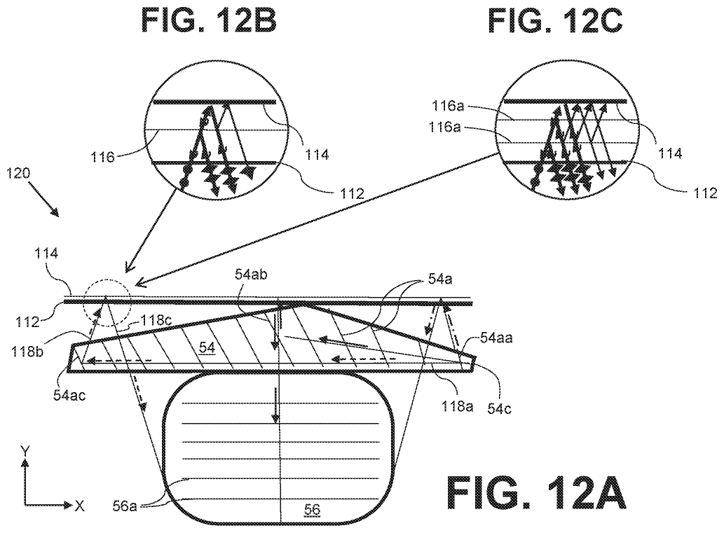

FIG. 12A and the system 120 correspond to the system 110 of FIG. 11A but modified to include at least one modified partial reflector (also referred to as ‘homogenizer’) 116. FIG. 12B illustrates a first alternative magnified view. In the embodiment of FIG. 12B, system 120 includes a partially reflecting surface 116. In the embodiment of FIG. 12C, system 120 includes two partially reflecting surfaces 116a and 116b. By using partially reflecting surfaces 116 or 116a, 116b, a more uniform illumination of the waveguide system 120 (compared to the system 110) can be achieved at smaller spacing between first partial reflector (116 or 116a) and the reflecting surface 114. Implementing one or more partial reflectors 116 in the waveguide system 120 as shown generates multiple beams that makes the output image more uniform. In FIGS. 12B and 12C the partial reflectors 116 or 116a, 116b are disposed between the waveplate 112 and the reflector 114.

FIG. 12B illustrates the reflection of one of the light beams while the other light beams experience the same optical process. The impinging beam (S-polarized) is converted to circular polarization after passing through waveplate 112. As this beam impinges on partial reflector 116, part is reflected and part is transmitted to be reflected by the reflecting surface 114. Multiple reflections continue and generate more beams with reduced intensity. All these beams reflect back through waveplate 112 and emerge as P-polarized toward facets 56a.

In some configurations, no waveplate is needed and only reflector 114 exists. In some configurations only partial reflector 116 and reflector 114 exists. In all the above configurations, the HLOE 54 may be on the side or below the LOE facets 56a. The facets 56a may be reoriented accordingly (in respect to HLOE 54) to couple the beams out of the waveguide section 56. In some configurations, the partial reflector 116 may be in the optical path before the waveplate 112, thereby some of the reflections are P-polarized and some S-polarized, generating practically an un-polarized beam. The reflectivity of the partial reflectors 116 needs to be numerically optimized to achieve maximal and uniform power output from the system 120.

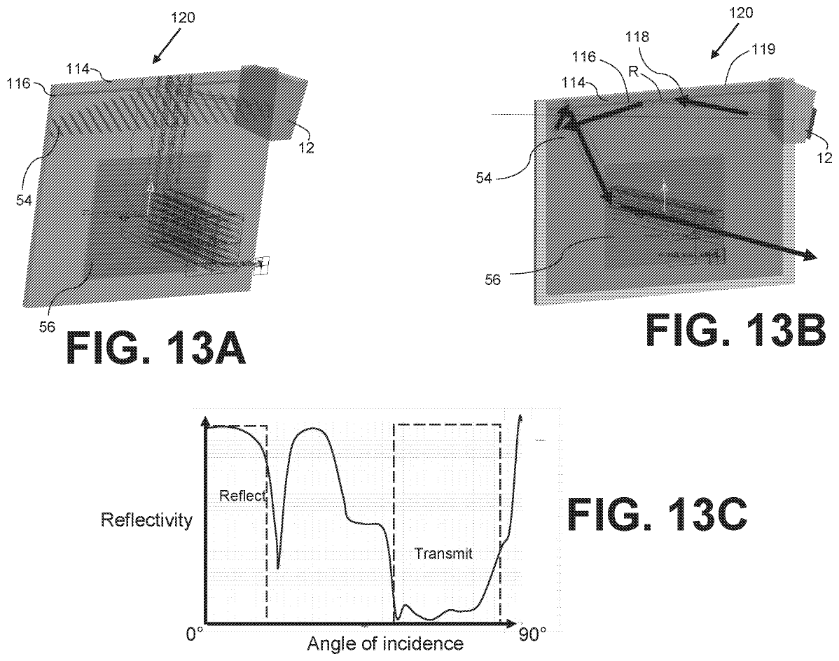

FIG. 13A illustrates system 120 corresponding to the configuration of FIG. 12A. FIG. 13A illustrates the nominal image beam path. FIG. 13B, on the other hand, illustrates an undesired beam-path (ghost). Here the beam 118 is transmitted through the facets of the HLOE 54 to be reflected first by reflective surface 114 and partial reflector 116 at reflection point R, then reflected by the facets of the HLOE 54 and continues as a nominal beam to be reflected by the facets of the LOE 56 and eventually generating an undesired ‘ghost’ image. The reflection of the ‘ghost’ beam at reflection point R is at a high angle, while the nominal reflections (as in FIG. 13A) are at small angles relative to reflectors 114 and 116. Therefore, it is possible to design an angularly selective dielectric coating on reflectors 114 and 116 as shown in FIG. 13C. The dielectric coating is designed such that incident angle zero to twenty degrees will experience the required reflectivity (preferably at both polarizations) while high angles such as sixty to eighty degrees will not be reflected (i.e., transmitted instead) by the reflectors 114 and 116. As shown in FIG. 13B, system 120 may include a light absorber 119 to absorb any light transmitted by the reflector 114 (i.e., would be ‘ghost’).

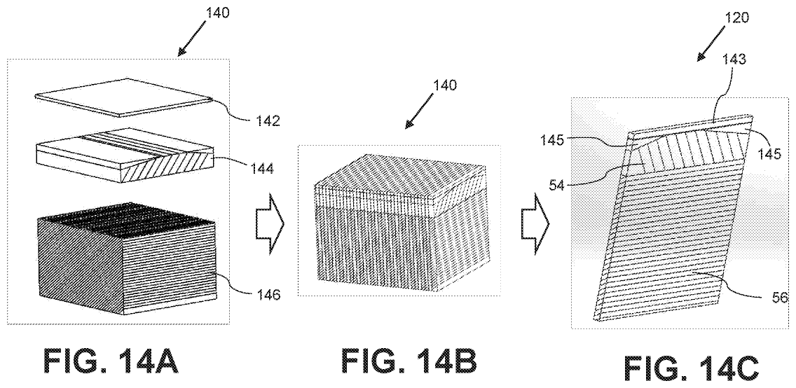

FIGS. 14A, 14B, and 14C illustrate an exemplary production process for constructing the system 120 as shown in FIG. 12A. FIG. 14A illustrates a stack 140 that includes a reflector plate 142, an HLOE stack 144, and an LOE stack 146.

The reflector plate 142 may include (stacked) reflector 114 on top, waveplate 112, and partial reflector 116 at the bottom of the plate 142. Different order of these parts is possible, as previously described.

HLOE stack 144 includes HLOE 54 and clear sections 145. The HLOE stack 144 is produced by stacking partial reflectors (stacked plates having partially reflecting coating) and slicing the resulting structure to the shape shown in FIG. 14A. The HLOE 54 facets may be perpendicular to the external faces of the waveguide or may be oblique to the external faces. Clear sections 145 are added thereupon such that the top surface of the HLOE stack 144 is parallel to its bottom surface. LOE stack 146 is made of stacked plates having partially reflecting coating. The LOE stack 146 is sliced to shape as shown.

FIG. 14B illustrates the combined stacks (142, 144, 146). This combined stack 140 is sliced on parallel planes that are perpendicular to the facets of the LOE 56 and parallel to reflecting surfaces 114 and 116 of the sliced reflector plate 143.

As shown in FIG. 14C, the slice generated corresponds to the system 120 of FIG. 12A. The system 120 may, thus, include a plate 143 including a quarter waveplate 112, one or more partially reflecting surfaces 116, and one or more reflectors 114. The plate 143 may be disposed on a side of the first waveguide section (HLOE) 54 opposite the second waveguide section 56 such that (1) the first set of at least partially reflecting surfaces 54a couples the light corresponding to the image out of the first waveguide section 54 towards the plate 143, (2) the quarter waveplate 112 rotates polarization of the light a quarter wave, (3) the one or more partially reflecting surfaces 116 partially transmit and partially reflect the light, (4) the one or more reflectors 114 reflect the transmitted light back through the one or more partially reflecting surfaces 116 and the quarter waveplate 112, (5) the one or more partially reflecting surfaces 116 partially transmit and partially reflect the reflected light, (6) the quarter waveplate 112 rotates polarization of the light an additional quarter wave, and (7) the light travels through the first waveguide section 54 towards the second waveguide section 56.

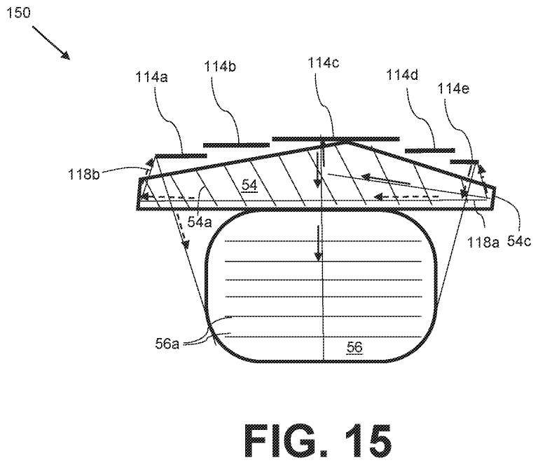

FIG. 15 illustrates a waveguide system 150 similar to the system 120, but here the reflective surface 114 (and/or the plate 143) is segmented as parallel reflective surfaces 114a-e. The segmentation of the reflecting surfaces 114 enables shorter back reflection 118b (compared to reflection 118b in FIG. 12A) and, therefore, allows for a shorter HLOE 54. Furthermore, this arrangement enables an approximately rounded NED frame 18 that is more ergonomic and perhaps more aesthetically pleasing. The impact of discontinuities between the reflecting segments 114a-e may be prevented from being projected onto the image by assuring small spacing between the HLOE facets 54a. In addition to the reflective surfaces 114a-e, the quarter plate 112, the partial reflectors 116, and the light absorber 119 may also be segmented along the same segments shown in FIG. 15.

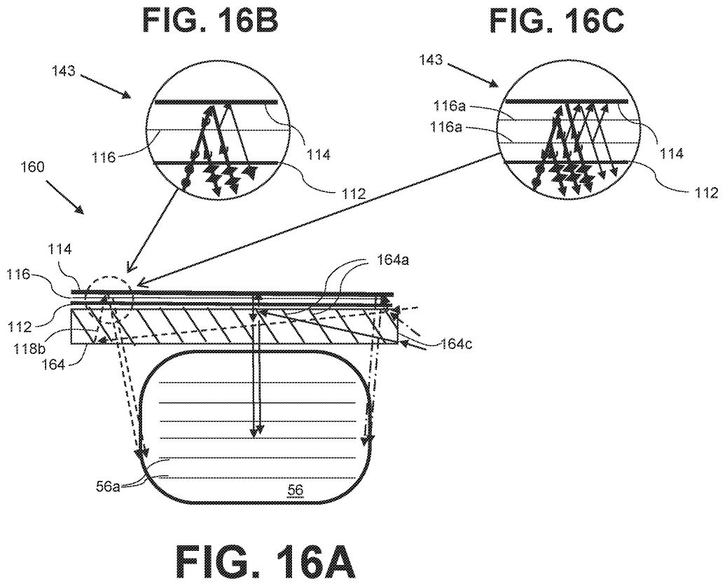

FIGS. 16A, 16B, and 16C illustrate a waveguide system 160 that combines features of the system 60a of FIG. 6 and the system 120 of FIG. 12A. The system 160 is an implementation of reversed facets 164a and reflective surface 114 (equivalent to the facets 54a and the reflective surface 114 of system 120) combined with a distributed/large aperture 164c (equivalent to the aperture 64c of system 60a). In this configuration, the location of beams in the aperture 164c is different compared to the location of beams in the aperture 64c (mostly opposite vertically), but the result is the same. By combining the reversed facets 164a and reflective surface 114 with the distributed/large aperture 164c, the width of the HLOE section 164 may be narrower (facets 164a compared to facets 54a). Furthermore, the length of HLOE 54 may be shortened because the reflected pass 118b at the edge of the field is much shorter.

The result is a compact waveguide system 160 that may be used to produce smaller NED.

### Definitions

The following includes definitions of selected terms employed herein. The definitions include various examples or forms of components that fall within the scope of a term and that may be used for implementation. The examples are not intended to be limiting. Both singular and plural forms of terms may be within the definitions.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

1. A waveguide system for a near-eye display, comprising:
a first waveguide section having an aperture through which light beams corresponding to an image from an image projector enter the waveguide system, wherein the first waveguide section includes one or more first optical elements configured to couple light corresponding to the image out of the first waveguide section so as to expand the aperture in a first dimension; and
a second waveguide section disposed on a first side of the first waveguide section and configured to receive light from the first waveguide section and including one or more second optical elements configured to couple out light corresponding to the image so as to expand the aperture in a second dimension nonparallel to the first dimension;
one or more reflectors disposed on a second side of the first waveguide section opposite the first side, wherein (1) the one or more first optical elements couple the light corresponding to the image out of the first waveguide section towards the one or more reflectors and (2) the one or more reflectors reflect the light corresponding to the image back through the first waveguide section towards the second waveguide section.

2. The waveguide system of claim 1, wherein the one or more first optical elements correspond to a first set of parallel partially reflecting surfaces or to a first diffractive grating and the one or more second optical elements correspond to a second set of parallel partially reflecting surfaces or to a second diffractive grating.

3. The waveguide system of claim 1,
the waveguide system including:
a plate including a quarter waveplate and the one or more reflectors, the plate disposed such that (1) the one or more first optical elements couple the light corresponding to the image out of the first waveguide section towards the plate, (2) the quarter waveplate rotates polarization of the light a quarter wave, (3) the one or more reflectors reflect the transmitted light back through the quarter waveplate, (4) the quarter waveplate rotates polarization of the light an additional quarter wave, and (5) the light travels through the first waveguide section towards the second waveguide section.

4. The waveguide system of claim 1, wherein the one or more first optical elements correspond to a first set of at least partially reflecting surfaces and the one or more second optical elements correspond to a second set of at least partially reflecting surfaces, wherein (1) a first extreme light beam from the light beams is at least partially reflected by a first extreme at least partially reflecting surface from the first set of at least partially reflecting surfaces, (2) a second extreme light beam from the light beams, opposite the first extreme light beam, is at least partially reflected by a second extreme at least partially reflecting surface from the first set of at least partially reflecting surfaces, opposite the first extreme at least partially reflecting surface from the first set of at least partially reflecting surfaces, and (3) a center light beam from the light beams is at least partially reflected by a third at least partially reflecting surface from the first set of at least partially reflecting surfaces disposed between the first and second extreme at least partially reflecting surfaces.

5. The waveguide system of claim 1, comprising:
a quarter waveplate disposed optically between the first waveguide section and the one or more reflectors such that (1) the one or more first optical elements couple the light corresponding to the image out of the first waveguide section towards the quarter waveplate and the one or more reflectors, (2) the quarter waveplate rotates polarization of the light a quarter wave, (3) the one or more reflectors reflect the light back through the quarter waveplate, (4) the quarter waveplate rotates polarization of the light an additional quarter wave, and (5) the light travels through the first waveguide section towards the second waveguide section.

6. The waveguide system of claim 1, comprising:
a plate including a quarter waveplate, one or more partially reflecting surfaces, and the one or more reflectors, the plate disposed such that (1) the one or more first optical elements couple the light corresponding to the image out of the first waveguide section towards the plate, (2) the quarter waveplate rotates polarization of the light a quarter wave, (3) the one or more partially reflecting surfaces partially transmit and partially reflect the light, (4) the one or more reflectors reflect the transmitted light back through the one or more partially reflecting surfaces and the quarter waveplate, (5) the one or more partially reflecting surfaces partially transmit and partially reflect the reflected light, (6) the quarter waveplate rotates polarization of the light an additional quarter wave, and (7) the light travels through the first waveguide section towards the second waveguide section.

7. The waveguide system of claim 1, comprising:
one or more partially reflecting surfaces disposed optically between the first waveguide section and the one or more reflectors such that (1) the one or more first optical elements couple the light corresponding to the image out of the first waveguide section through the second and the third major surfaces towards the one or more partially reflecting surfaces and the one or more reflectors, (2) the one or more partially reflecting surfaces partially transmit and partially reflect the light, (3) the one or more reflectors reflect the transmitted light back through the one or more partially reflecting surfaces, (4) the one or more partially reflecting surfaces partially transmit and partially reflect the reflected light, and (5) the transmitted light travels through the first waveguide section towards the second waveguide section.

8-41 (canceled)
